(19) United States
(12) Patent Application Publication
(10) Pub. No.: US 2026/0141857 A1
(43) Pub. Date: May 21, 2026

(54) DISPLAY APPARATUS

(71) Applicant: LG Display Co., Ltd., Seoul (KR)

(72) Inventors: Doyoung JUNG, Paju-si (KR); Sanghyuck BAE, Paju-si (KR); Byeongseong SO, Paju-si (KR)

(73) Assignee: LG Display Co., Ltd., Seoul (KR)

(21) Appl. No.: 19/387,087

(22) Filed: Nov. 12, 2025

(30) Foreign Application Priority Data
Nov. 18, 2024 (KR) 10-2024-0164378

(51) Int. Cl. G09G 3/3233

(52) U.S. Cl. CPC G09G 3/3233; G09G 2300/0452; G09G 2300/0819; G09G 2300/0852; G09G 2310/08; G09G 2330/021

(57) ABSTRACT

A display apparatus according to one embodiment includes a light-emitting element that emits light, a first transistor that controls a driving current flowing in the light-emitting element, a second transistor that supplies a data voltage to a first node, which is a gate electrode of the first transistor, based on a first scan signal, a third transistor that supplies an initialization voltage to a second node, which is a source electrode of the first transistor, based on a second scan signal, a fourth transistor that supplies a hold signal to a third node, based on the first scan signal, a fifth transistor that electrically connects a reference voltage line to the first node based on a voltage of the third node, and a sixth transistor that electrically connects the second node to a sensing line based on a voltage of the third node.

### CROSS-REFERENCE TO RELATED APPLICATION

The present application claims priority to Korean Patent Application No. 10-2024-0164378, filed Nov. 18, 2024, the entire contents of which is incorporated herein for all purposes by this reference.

### BACKGROUND

### Technical Field

The present specification relates to a display apparatus.

### Description of the Related Art

As the information society develops, various demands for display apparatuses for displaying images are increasing, and various types of display apparatuses such as liquid crystal display (LCD) apparatuses and organic light emitting diode (OLED) display apparatuses are utilized.

Images displayed on a display apparatus may be still images or moving images, and the moving image may include various types such as sports images, game images, and movies. The display apparatus may include a plurality of pixels, and a plurality of switching elements for driving the pixels.

### BRIEF SUMMARY

The present specification is directed to providing a display apparatus in which some pixels can be sensed in real time during display driving.

Features of the present specification are not limited to the above-described objects, and other technical features may be inferred from the following embodiments.

According to one embodiment, there is provided a display apparatus including a light-emitting element that emits light, a first transistor that controls a driving current flowing in the light-emitting element, a second transistor that supplies a data voltage to a first node, which is a gate electrode of the first transistor, based on a first scan signal, a third transistor that supplies an initialization voltage to a second node, which is a source electrode of the first transistor, based on a second scan signal, a fourth transistor that supplies a hold signal to a third node, based on the first scan signal, a fifth transistor that electrically connects a reference voltage line to the first node based on a voltage of the third node, and a sixth transistor that electrically connects the second node to a sensing line based on a voltage of the third node.

According to another embodiment, there is provided a display apparatus including a data line that supplies a data voltage, a display driver that supplies the data voltage to the data line, an initialization voltage line that supplies an initialization voltage, a reference voltage line that supplies a reference voltage, a light-emitting element that emits light during a driving section that is some of a plurality of frame periods, a sensing line that supplies a sensing signal to the display driver during a sensing section that is the other parts of the plurality of frame periods, a hold line that supplies a hold signal, a first transistor that controls a driving current flowing in the light-emitting element, a second transistor electrically connecting the data line to a first node that is a gate electrode of the first transistor based on a first scan signal, a third transistor electrically connecting the initialization voltage line to a second node that is a source electrode of the first transistor based on a second scan signal, a fourth transistor electrically connecting the hold line to a third node based on the first scan signal, a fifth transistor electrically connecting the reference voltage line to the first node based on a voltage of the third node, a sixth transistor electrically connecting the second node to the sensing line based on the voltage of the third node, a first capacitor connected between the first node and the second node, and a second capacitor connected between the third node and the reference voltage line.

Detailed matters of other embodiments are included in the detailed description and accompanying drawings.

### BRIEF DESCRIPTION OF THE SEVERAL VIEWS OF THE DRAWINGS

FIG. 1 is a plan view illustrating a display apparatus according to one embodiment.

FIG. 2 is a block diagram illustrating the display apparatus according to one embodiment.

FIG. 3 is a view illustrating a connection relationship between a pixel and lines in the display apparatus according to one embodiment.

FIG. 4 is a view illustrating a connection relationship between sub-pixels and lines in the display apparatus according to one embodiment.

FIG. 5 is a circuit diagram illustrating a circuit of the display apparatus according to one embodiment.

FIG. 6 is a waveform diagram illustrating signals applied to a sub-pixel during a sensing section in the display apparatus according to one embodiment.

FIG. 7 is a circuit diagram illustrating the operation of the sub-pixel during the sensing section in the display apparatus according to one embodiment.

FIG. 8 is a waveform diagram illustrating signals applied to the sub-pixel during a driving section in the display apparatus according to one embodiment.

FIG. 9 is a circuit diagram illustrating the operation of the sub-pixel in a first period of the driving section in the display apparatus according to one embodiment.

FIG. 10 is a circuit diagram illustrating the operation of the sub-pixel in a second period of the driving section in the display apparatus according to one embodiment.

FIG. 11 is a waveform diagram illustrating signals of the driving section and the sensing section in the display apparatus according to one embodiment.

FIG. 12 is a view illustrating an example of a sensing method in the display apparatus according to one embodiment.

FIG. 13 is a view illustrating an example of the sensing method in the display apparatus according to one embodiment.

### DETAILED DESCRIPTION

Hereinafter, embodiments will be described with reference to the accompanying drawings. In the specification, when a first component (or an area, a layer, a portion, etc.) is described as “on,” “connected,” or “coupled to” a second component, it means that the first component may be directly connected/coupled to the second component or a third component may be disposed therebetween.

The same reference numerals indicate the same components. In addition, in the drawings, thicknesses, proportions, and dimensions of components are exaggerated for effective description of technical contents. The term “and/or” includes all one or more combinations that may be defined by the associated configurations.

Terms such as first and second may be used to describe various components, but the components are not limited by the terms. The terms are used only for the purpose of distinguishing one component from another. For example, a first component may be referred to as a second component, and similarly, the second component may also be referred to as the first component without departing from the scopes of the embodiments. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof in advance.

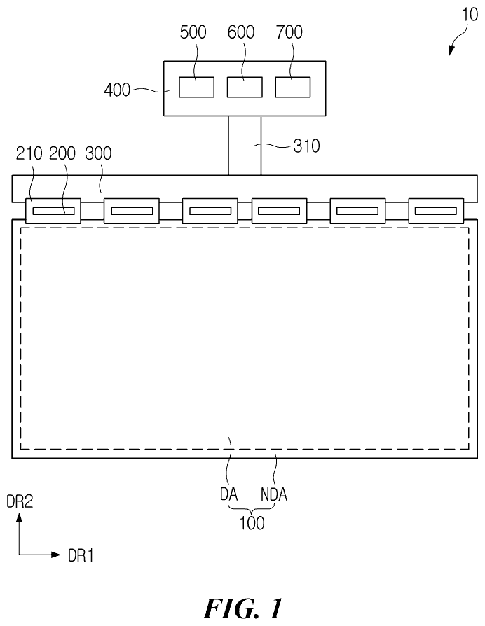

FIG. 1 is a plan view illustrating a display apparatus according to one embodiment.

Referring to FIG. 1, a display apparatus 10 may be applied to portable electronic devices, such as a mobile phone, a smart phone, a tablet personal computer (PC), a mobile communication terminal, an electronic notebook, an electronic book, a portable multimedia player (PMP), a navigation device, an ultra-mobile PC (UMPC), etc. For example, the display apparatus 10 may be applied to a television, a laptop, a monitor, a billboard, or a display unit of the Internet of Things (IOT). As another example, the display apparatus 10 may be applied to a wearable device, such as a smart watch, a watch phone, a glasses-type display, and a head mounted display (HMD).

The display apparatus 10 may include a display panel 100, a display driver 200, a flexible film 210, a source circuit board 300, a flexible cable 310, a control circuit board 400, a timing controller 500, a power supply unit 600, and a memory 700.

The display panel 100 may include a display area DA and a non-display area NDA. The display area DA may include a plurality of pixels that display an image. The pixel may include a plurality of sub-pixels, and each of the plurality of sub-pixels may emit light from a light-emitting area or an opening area. For example, the display area DA may include a pixel circuit including switching elements, a pixel definition film that defines a light-emitting area, and a self-light-emitting element.

For example, the self-light-emitting element may include at least one of an organic light emitting diode (OLED) including an organic light-emitting layer, a quantum dot LED including a quantum dot light-emitting layer, an inorganic LED including an inorganic semiconductor, and an ultra-small light emitting diode (a micro LED or a nano LED), but is not limited thereto.

The display driver 200 may supply a data voltage to a data line of the display panel 100. The display driver 200 may be electrically connected to the data line of the display panel 100 through a flexible film 210 and a pad part of the display panel 100. The display driver 200 may be formed as an integrated circuit (IC). For example, the display driver 200 may be attached to one surface of the flexible film 210 in a chip on film (COF) manner. The flexible film 210 may include lines electrically connecting the display driver 200 to the display panel 100. One side of the flexible film 210 may be electrically connected to the pad part of the display panel 100, and the other side of the flexible film 210 may be electrically connected to the source circuit board 300.

The source circuit board 300 may electrically connect the control circuit board 400 to the flexible film 210. The source circuit board 300 may be a printed circuit board including lines electrically connecting the display driver 200 to other devices. The source circuit board 300 may be electrically connected to the control circuit board 400 through the flexible cable 310. For example, the flexible cable 310 may be a flexible flat cable (FFC), but is not limited thereto.

The control circuit board 400 may be a printed circuit board on which the timing controller 500, the power supply unit 600, and the memory 700 are mounted. The control circuit board 400 is not limited to that of FIG. 1 and may have control components and various electrical devices mounted thereon.

The timing controller 500 may be attached to one surface of the control circuit board 400. The timing controller 500 may control the driving timing of the display driver 200 by transmitting digital video data to the display driver 200.

The power supply unit 600 may generate a power voltage and supply the generated power voltage to the display panel 100. Here, the power voltage may include a driving voltage EVDD, a low-potential voltage EVSS, an initialization voltage Vint, a reference voltage Vref, and a bias voltage Vbias, but is not limited thereto.

The memory 700 may store sensing information of pixels. For example, the memory 700 may store threshold voltage information of a transistor, which is received from the display driver 200 and supply the threshold voltage information to the timing controller 500.

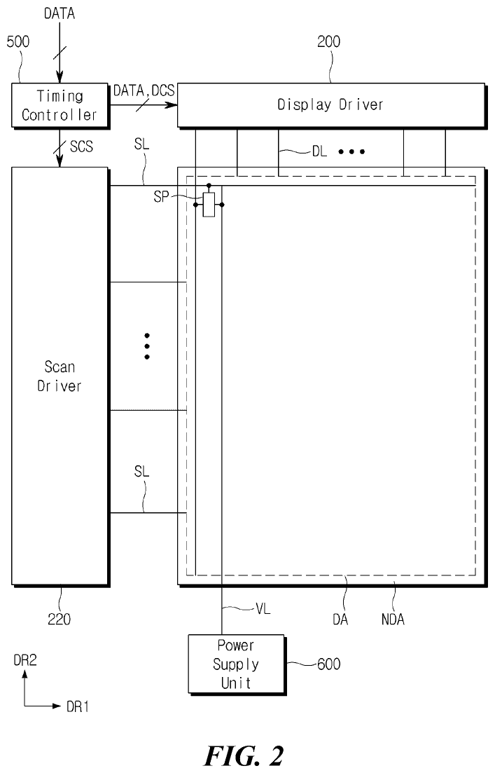

FIG. 2 is a block diagram illustrating the display apparatus according to one embodiment.

Referring to FIG. 2, the display panel 100 may include the display area DA and the non-display area NDA. The display area DA may include a plurality of sub-pixels SP, and a power line VL, a scan line SL, and a data line DL that are connected to the sub-pixel SP.

Each of the plurality of sub-pixels SP may be connected to the scan line SL, the data line DL, and the power line VL. Each of the plurality of sub-pixels SP may include a transistor, a light-emitting element, and a capacitor.

The scan lines SL may extend in a first direction DR1 and may be spaced apart from each other in a second direction DR2 intersecting the first direction DR1. The scan lines SL may sequentially supply scan signals to the plurality of sub-pixels SP.

The data lines DL may extend in the second direction DR2 and may be spaced apart from each other in the first direction DR1. The data line DL may supply the data voltage to the sub-pixel SP. The data voltage may determine the luminance of the sub-pixel SP.

The power lines VL may extend in the second direction DR2 and may be spaced apart from each other in the first direction DR1. The power line VL may supply a power voltage to the plurality of sub-pixels SP. The power voltage may include the driving voltage EVDD, the low-potential voltage EVSS, the initialization voltage Vint, the reference voltage Vref, and the bias voltage Vbias, but is not limited thereto.

A scan driver 220 may include a plurality of transistors and generate scan signals based on a scan control signal SCS. The scan driver 220 may shift the scan signals using a shift register and sequentially supply the shifted scan signals to scan lines SL. The scan signals of the scan driver 220 may select the sub-pixels SP to which the data voltage is supplied, and the selected sub-pixels SP may receive the data voltage through the data lines DL. The scan driver 220 may be disposed on one side or both sides of a non-display area NDA in a gate in panel (GIP) manner.

The timing controller 500 may receive digital video data DATA and timing signals from a display driving system or a graphic device (not illustrated). The timing controller 500 may generate a data control signal DCS based on the timing signals. The timing controller 500 may control the operation timing of the display driver 200 by supplying the digital video data DATA and the data control signal DCS to the display driver 200. The display driver 200 may convert the digital video data DATA into analog data voltages and supply the analog data voltages to the data lines DL. The timing controller 500 may generate the scan control signal SCS based on the timing signals. The timing controller 500 may control the operation timing of the scan driver 220 by supplying the scan control signal SCS to the scan driver 220.

The power supply unit 600 may supply a power voltage to the power line VL. The power voltage may include the driving voltage EVDD, the low-potential voltage EVSS, the initialization voltage Vint, the reference voltage Vref, and the bias voltage Vbias, but is not limited thereto. The power supply unit 600 may generate the driving voltage EVDD and supply the driving voltage EVDD to a driving voltage line, generate the initialization voltage Vint and supply the initialization voltage Vint to an initialization voltage line, generate the bias voltage Vbias and supply the bias voltage Vbias to a bias voltage line, generate the reference voltage Vref and supply the reference voltage Vref to a reference voltage line, and generate the low-potential voltage EVSS and supply the low-potential voltage EVSS to a low-potential line.

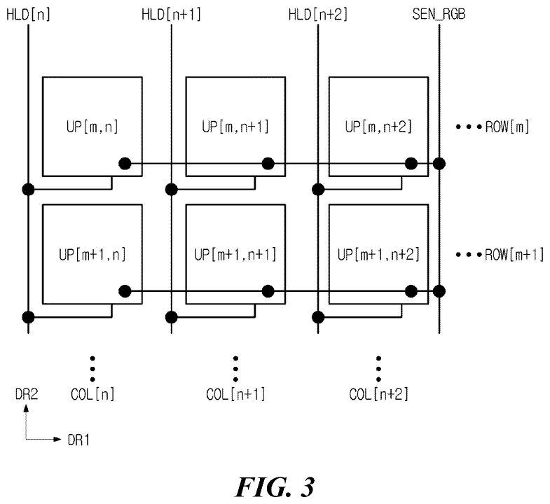

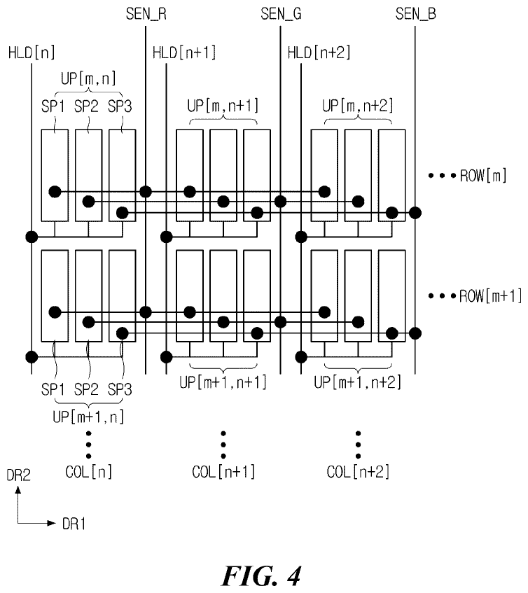

FIG. 3 is a view illustrating a connection relationship between a pixel and lines in the display apparatus according to one embodiment, and FIG. 4 is a view illustrating a connection relationship between sub-pixels and lines in the display apparatus according to one embodiment.

Referring to FIGS. 3 and 4, pixels UP may be arranged along a plurality of rows ROW and a plurality of columns COL. For example, the pixels UP may be arranged along m^{th} and (m+1)^{th} rows ROW[m] and ROW[m+1] (m is an integer that is more than or equal to 1) and nth, (n+1)^{th}, and (n+2)^{th} columns COL[n], COL[n+1], and COL[n+2] (n is an integer that is more than or equal to 1). One pixel UP may include the plurality of sub-pixels SP that emit light of different colors. For example, one pixel UP may include a first sub-pixel SP1 that emits red light, a second sub-pixel SP2 that emits green light, and a third sub-pixel SP3 that emits blue light.

A plurality of hold lines HLD may extend in the second direction DR2 and may be spaced apart from each other in the first direction DR1. An n^{th} hold line HLD[n] may supply a hold signal to pixels UP[m, n] and UP[m+1, n] disposed in an n^{th} column COL[n]. Here, the hold signal may select a pixel UP to be sensed. For example, when the hold signal is applied, the display driver 200 may sense a threshold voltage of a driving transistor of the corresponding pixel UP. When the hold signal is not applied, the display driver 200 may drive the corresponding pixel UP to emit light. The display driver 200 may select a small number of sub-pixels SP during display driving and sense a threshold voltage of a driving transistor. Accordingly, the display apparatus 10 may drive most of the sub-pixels SP to emit light and sense a small number of sub-pixels SP that are not recognized by a viewer's eyes, thereby sensing some of the sub-pixels SP in real time during display driving. An (n+1)^{th} hold line HLD[n+1] may supply the hold signal to pixels UP[m, n+1] and UP[m+1, n+1] disposed in an (n+1)^{th} column COL[n+1]. An (n+2)^{th} hold line HLD[n+2] may supply the hold signal to pixels UP[m, n+2] and UP[m+1, n+2] disposed in an (n+2)^{th} column COL[n+2].

In FIG. 3, a plurality of sensing lines SEN_RGB may extend in the second direction DR2 and may be spaced apart from each other in the first direction DR1. One sensing line SEN_RGB may receive sensing signals from the pixels UP[m, n], UP[m, n+1], UP[m, n+2], UP[m+1, n], UP[m+1, n+1], and UP[m+1, n+2]) disposed in the n^{th}, (n+1)^{th}, and (n+2)^{th} columns COL[n], COL[n+1], and COL[n+2]. The sensing line SEN_RGB may supply a sensing signal to the display driver 200, and the display driver 200 may receive the sensing signal and recognize a change in threshold voltage of the driving transistor. In FIG. 3, the sensing line SEN_RGB may be electrically connected to the pixels UP disposed in three columns COL, but the number of columns COL of the pixels UP connected to the sensing line SEN_RGB is not limited thereto. The sensing line SEN_RGB may include first to third sensing lines SEN_R, SEN_G, and SEN_B.

In FIG. 4, each of the first to third sensing lines SEN_R, SEN_G, and SEN_B may be electrically connected to the sub-pixels SP that emit light of the same color. A first sensing line SEN_R may receive sensing signals from the first sub-pixels SP1 of each of the pixels UP[m, n], UP[m, n+1], UP[m, n+2], UP[m+1, n], UP[m+1, n+1], and UP[m+1, n+2]. A second sensing line SEN_G may receive sensing signals from the second sub-pixels SP2 of each of the pixels UP[m, n], UP[m, n+1], UP[m, n+2], UP[m+1, n], UP[m+1, n+1], and UP[m+1, n+2]. A third sensing line SEN_B may receive sensing signals from the third sub-pixels SP3 of each of the pixels UP[m, n], UP[m, n+1], UP[m, n+2], UP[m+1, n], UP[m+1, n+1], and UP[m+1, n+2].

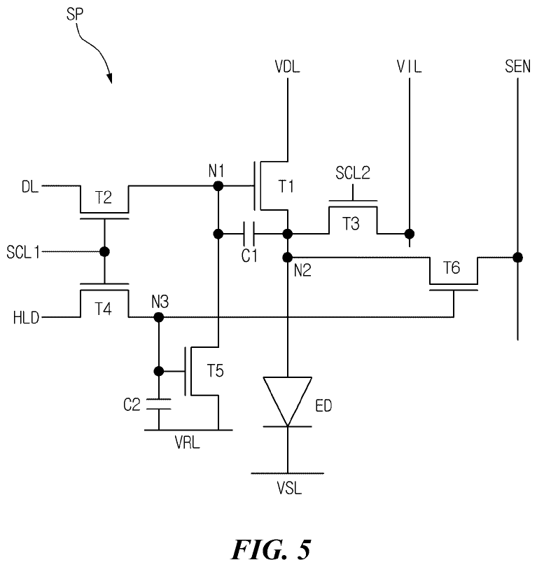

FIG. 5 is a circuit diagram illustrating a circuit of the display apparatus according to one embodiment.

Referring to FIG. 5, the sub-pixel SP may be connected to a first scan line SCL1, a second scan line SCL2, a hold line HLD, the data line DL, a reference voltage line VRL, a driving voltage line VDL, an initialization voltage line VIL, a sensing line SEN, and a low-potential line VSL.

The sub-pixel SP may include a pixel circuit and a light-emitting element ED. The pixel circuit may include first to sixth transistors T1, T2, T3, T4, T5, and T6, and first and second capacitors C1 and C2.

The first transistor T1 may include a gate electrode, a drain electrode, and a source electrode. The first transistor T1 may control a drain-source current (Ids) (or a driving current) according to the data voltage applied to the gate electrode. The driving current (Ids) flowing through a channel of the first transistor T1 may be proportional to the square of a difference between a threshold voltage (Vth) and a voltage (Vgs) between the gate electrode and the source electrode of the first transistor T1 (Ids=k×(Vgs−Vth)²). Here, k denotes a proportional coefficient determined by the structure and physical characteristics of the first transistor T1, Vgs denotes a gate-source voltage of the first transistor T1, and Vth denotes the threshold voltage of the first transistor T1. In the first transistor T1, a gate electrode may be electrically connected to a first node N1, a drain electrode may be electrically connected to the driving voltage line VDL, and a source electrode may be electrically connected to a second node N2. The first transistor T1 may be a driving transistor of the sub-pixel SP.

The light-emitting element ED may receive the driving current (Ids) and emit light. The amount of light emitted or the luminance of the light-emitting element ED may be proportional to the magnitude of the driving current (Ids). The light-emitting element ED may be an organic light-emitting diode including a first electrode, a second electrode, and an organic light-emitting layer disposed between the first electrode and the second electrode, but the type of the light-emitting element ED is not limited thereto.

The first electrode of the light-emitting element ED may be electrically connected to the second node N2. The first electrode of the light-emitting element ED may be electrically connected to a source electrode of the first transistor T1, a drain electrode of a third transistor T3, and a drain electrode of a sixth transistor T6 via the second node N2. Here, the first electrode of the light-emitting element ED may be an anode electrode or a pixel electrode. The second electrode of the light-emitting element ED may be electrically connected to the low-potential line VSL and may receive the low-potential voltage EVSS from the low-potential line VSL. Here, the second electrode of the light-emitting element ED may be a cathode electrode or a common electrode.

The second transistor T2 may be turned on by a first scan signal of the first scan line SCL1 to electrically connect the data line DL to the first node N1, which is the gate electrode of the first transistor T1. The second transistor T2 may be turned on based on the first scan signal to supply the data voltage to the first node N1. In the second transistor T2, a gate electrode may be electrically connected to the first scan line SCL1, a drain electrode may be electrically connected to the data line DL, and a source electrode may be electrically connected to the first node N1.

The third transistor T3 may be turned on by a second scan signal of the second scan line SCL2 to electrically connect the second node N2, which is the source electrode of the first transistor T1, to the initialization voltage line VIL. The third transistor T3 may be turned on based on the second scan signal to initialize the first electrode of the light-emitting element ED to the initialization voltage. In the third transistor T3, a gate electrode may be electrically connected to the second scan line SCL2, a drain electrode may be electrically connected to the second node N2, and a source electrode may be electrically connected to the initialization voltage line VIL.

The fourth transistor T4 may be turned on by the first scan signal of the first scan line SCL1 to electrically connect the hold line HLD to the third node N3, which is the first electrode of a second capacitor C2. The fourth transistor T4 may be turned on based on the first scan signal to charge the hold signal in the second capacitor C2. The hold signal charged in the third node N3 may be supplied to a gate electrode of each of the fifth and sixth transistors T5 and T6. In the fourth transistor T4, a gate electrode may be electrically connected to the first scan line SCL1, a drain electrode may be electrically connected to the hold line HLD, and a source electrode may be electrically connected to the third node N3.

The fifth transistor T5 may be turned on by a voltage of the third node N3 to electrically connect the reference voltage line VRL to the first node N1, which is the gate electrode of the first transistor T1. The fifth transistor T5 may be turned on based on the voltage of the third node N3 to supply the reference voltage Vref to the first node N1. In the fifth transistor T5, the gate electrode may be electrically connected to the third node N3, a drain electrode may be electrically connected to the reference voltage line VRL, and a source electrode may be electrically connected to the first node N1.

The sixth transistor T6 may be turned on by the voltage of the third node N3 to electrically connect the second node N2, which is the first electrode of the light-emitting element ED, to the sensing line SEN. The sixth transistor T6 may be turned on based on the voltage of the third node N3 to supply the sensing signal to the sensing line SEN. In the sixth transistor T6, the gate electrode may be electrically connected to the third node N3, a drain electrode may be electrically connected to the second node N2, and a source electrode may be electrically connected to the sensing line SEN.

The first to sixth transistors T1, T2, T3, T4, T5, and T6 may include an oxide-based active layer. The first to sixth transistors T1, T2, T3, T4, T5, and T6 may correspond to n-type transistors and output a current flowing into the drain electrode to the source electrode based on the gate high voltage applied to the gate electrode. The oxide-based active layer may have a relatively small S-factor, increase a constant current driving area in a low-gray area, and improve low-gray expression.

As another example, at least one of the first to sixth transistors T1, T2, T3, T4, T5, and T6 may include an active layer formed of low-temperature polycrystalline silicon (LTPS). At least one of the first to sixth transistors T1, T2, T3, T4, T5, and T6 may correspond to a p-type transistor and output a current flowing into the source electrode to the drain electrode based on the gate low voltage applied to the gate electrode.

The first capacitor C1 may be electrically connected between the first node N1, which is the gate electrode of the first transistor T1, and the second node N2, which is the source electrode of the first transistor T1. For example, a first electrode of the first capacitor C1 may be electrically connected to the first node N1, and a second electrode of the first capacitor C1 may be electrically connected to the second node N2, thereby maintaining a potential difference between the gate electrode and the source electrode of the first transistor T1.

The second capacitor C2 may be electrically connected between the third node N3 and the reference voltage line VRL. For example, a first electrode of the second capacitor C2 may be electrically connected to the third node N3, and a second electrode of the second capacitor C2 may be electrically connected to the reference voltage line VRL, thereby maintaining a potential difference between the third node N3 and the reference voltage line VRL.

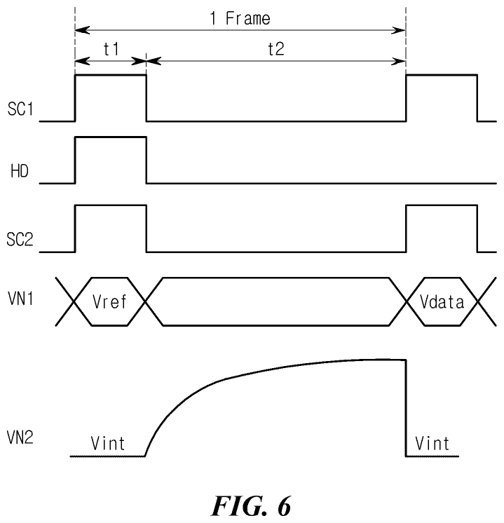

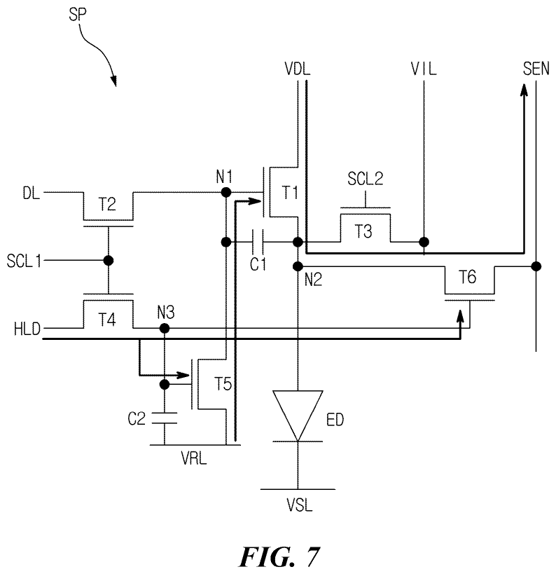

FIG. 6 is a waveform diagram illustrating signals applied to a sub-pixel during a sensing section in the display apparatus according to one embodiment, and FIG. 7 is a circuit diagram illustrating the operation of the sub-pixel during the sensing section in the display apparatus according to one embodiment.

Referring to FIGS. 6 and 7, the sub-pixel SP may be connected to the first scan line SCL1, the second scan line SCL2, the hold line HLD, the data line DL, the reference voltage line VRL, the driving voltage line VDL, the initialization voltage line VIL, the sensing line SEN, and the low-potential line VSL. The sub-pixel SP may include the first to sixth transistors T1, T2, T3, T4, T5, and T6, the first and second capacitors C1 and C2, and the light-emitting element ED. The display driver 200 may receive the sensing signal during the sensing section to recognize a change in threshold voltage of the first transistor T1.

The first scan line SCL1 may supply a first scan signal SC1 of a high level during a first period t1 of one frame period. The hold line HLD may supply the hold signal HD of a high level during the first period t1 of one frame period. The fourth transistor T4 may be turned on during the first period t1, and the hold line HLD may supply the hold signal HD of a high level to the third node N3. The hold signal HD of a high level may be charged to the third node N3, which is the first electrode of the second capacitor C2.

Each of the fifth and sixth transistors T5 and T6 may be turned on based on the voltage of the third node N3 during the first and second periods t1 and t2 of one frame period. The fifth transistor T5 may be turned on during the first and second periods t1 and t2 of one frame period to supply the reference voltage Vref to the first node N1, which is the gate electrode of the first transistor T1. Accordingly, a voltage VN1 of the first node N1 may correspond to the reference voltage Vref during the first and second periods t1 and t2. The sixth transistor T6 may be turned on during the first and second periods t1 and t2 of one frame period to electrically connect the second node N2, which is the source electrode of the first transistor T1, to the sensing line SEN.

The second scan line SCL2 may supply a second scan signal SC2 of a high level during the first period t1 of one frame period. The third transistor T3 may be turned on during the first period t1, and the second node N2, which is the source electrode of the first transistor T1, may be discharged to the initialization voltage Vint. Accordingly, a voltage VN2 of the second node N2 may correspond to the initialization voltage Vint during the first period t1.

During the first period t1, the gate electrode of the first transistor T1 may receive the reference voltage Vref, and the source electrode of the first transistor T1 may receive the initialization voltage Vint, and thus a gate-source voltage (Vgs) of the first transistor T1 may be greater than the threshold voltage Vth of the first transistor T1, and the first transistor T1 may be turned on during the second period t2 so that a drain-source current (Ids) may flow in the first transistor T1. As the drain-source current (Ids) flows during the second period t2, the voltage VN2 of the second node N2 may increase. The voltage VN2 of the second node N2 may increase until the gate-source voltage (Vgs) of the first transistor T1 becomes equal to the threshold voltage (Vth). When the gate-source voltage (Vgs) becomes equal to the threshold voltage (Vth), the first transistor T1 may be turned off so that the drain-source current (Ids) may no longer flow. Accordingly, when there is no change in the threshold voltage (Vth), the voltage VN2 of the second node N2 may be relatively higher, and when the threshold voltage (Vth) increases, the voltage VN2 of the second node N2 may be relatively lower.

The drain-source current (Ids) flowing in the first transistor T1 may flow to the sensing line SEN when the sixth transistor T6 is turned on. Here, when the sixth transistor T6 is turned on, internal resistance of the sixth transistor T6 may be smaller than internal resistance of the light-emitting element ED, and the entirety of the drain-source current (Ids) may flow to the sensing line SEN. The sixth transistor T6 may supply the voltage VN2 of the second node N2 to the sensing line SEN as a sensing signal, and the display driver 200 may recognize the change in the threshold voltage (Vth) of the first transistor T1 according to a magnitude of the sensing signal.

The sub-pixel SP may not emit light during the sensing section. The hold signal HD may select the pixel UP to be sensed. When the hold signal is applied, the display driver 200 may sense the threshold voltage of the first transistor T1 of the corresponding pixel UP. When the hold signal HD is not applied, the display driver 200 may drive the corresponding pixel UP to emit light. The display driver 200 may select a small number of sub-pixels SP during display driving and sense a threshold voltage of a first transistor T1. Accordingly, the display apparatus 10 may drive most of the sub-pixels SP to emit light and sense a small number of sub-pixels SP that are not recognized by a viewer's eyes, thereby sensing some of the sub-pixels SP in real time during display driving.

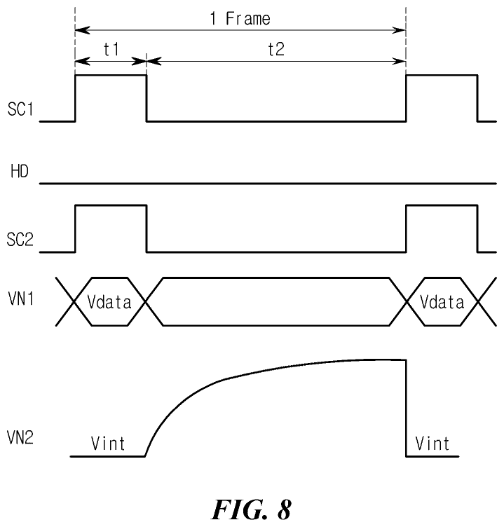

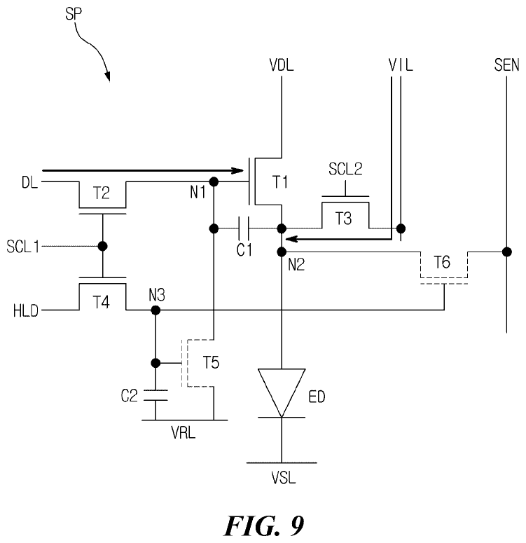

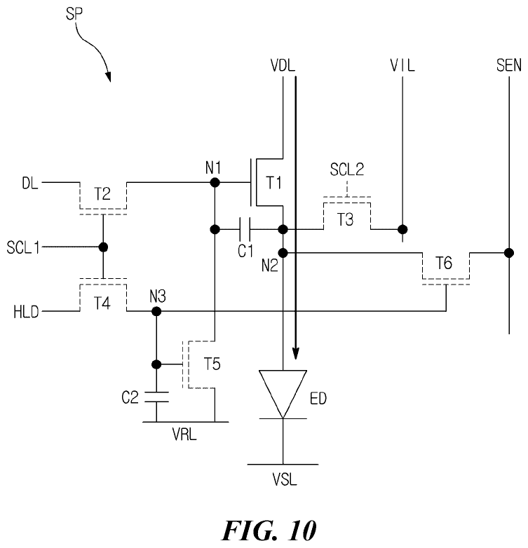

FIG. 8 is a waveform diagram illustrating signals applied to the sub-pixel during a driving section in the display apparatus according to one embodiment, FIG. 9 is a circuit diagram illustrating the operation of the sub-pixel in a first period of the driving section in the display apparatus according to one embodiment, and FIG. 10 is a circuit diagram illustrating the operation of the sub-pixel in a second period of the driving section in the display apparatus according to one embodiment.

Referring to FIGS. 8 to 10, the first scan line SCL1 may supply the first scan signal SC1 of a high level during the first period t1 of one frame period. The first scan line SCL1 may supply the first scan signal SC1 of a low level during the second period t2 of one frame period. The hold line HLD may supply the hold signal HD of a low level during the first and second periods t1 and t2 of one frame period. The fourth transistor T4 may be turned on during the first period t1, and the hold line HLD may supply the hold signal HD of a low level to the third node N3. Accordingly, each of the fifth and sixth transistors T5 and T6 may be turned off based on the voltage of the third node N3 during the first and second periods t1 and t2 of one frame period.

The second scan line SCL2 may supply the second scan signal SC2 of a high level during the first period t1 of one frame period. The second scan line SCL2 may supply the second scan signal SC2 of a low level during the second period t2 of one frame period.

In FIG. 9, the second transistor T2 may be turned on during the first period t1 of one frame period to supply the data voltage Vdata to the first node N1, which is the gate electrode of the first transistor T1. Accordingly, the voltage VN1 of the first node N1 may correspond to the data voltage Vdata during the first period t1.

The third transistor T3 may be turned on during the first period t1, and the second node N2, which is the source electrode of the first transistor T1, may be discharged to the initialization voltage Vint. Accordingly, the voltage VN2 of the second node N2 may correspond to the initialization voltage Vint during the first period t1.

Accordingly, during the first period t1, the gate electrode of the first transistor T1 may receive the data voltage Vdata, and the source electrode of the first transistor T1 may receive the initialization voltage Vint, and thus the gate-source voltage (Vgs) of the first transistor T1 may be greater than the threshold voltage (Vth) of the first transistor T1.

In FIG. 10, the first transistor T1 may be turned on during the second period t2, and the drain-source current (Ids) may flow in the first transistor T1. As the drain-source current (Ids) flows during the second period t2, the voltage VN1 of the first node N1 and the voltage VN2 of the second node N2 may increase. The first capacitor C1 may maintain a potential difference between the gate electrode (first node N1) and the source electrode (second node N2) of the first transistor T1. When the gate-source voltage (Vgs) is maintained by the first capacitor C1, a constant drain-source current (Ids) may flow.

The light-emitting element ED may receive the drain-source current (Ids) of the first transistor T1 and emit light. The amount of light emitted or the luminance of the light-emitting element ED may be proportional to the magnitude of the driving current (Ids) determined by the magnitude of the data voltage Vdata. The voltage VN2 of the second node N2 may increase according to the magnitude of the data voltage Vdata and determine the luminance of the light-emitting element ED.

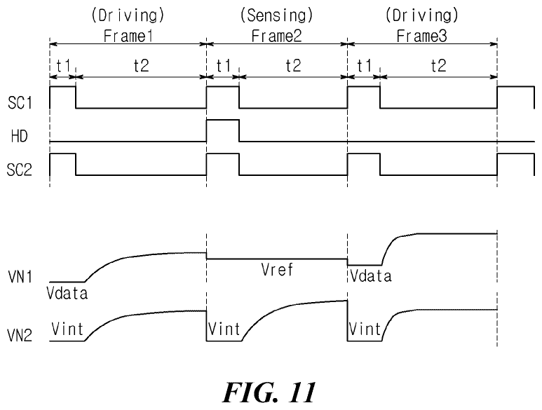

FIG. 11 is a waveform diagram illustrating signals of the driving section and the sensing section in the display apparatus according to one embodiment.

Referring to FIGS. 5 and 11, the sub-pixel SP may be driven during driving sections or sensing sections in a plurality of frame periods.

The sub-pixel SP may be driven during a driving section of a first frame period Frame1. The first scan line SCL1 may supply the first scan signal SC1 of a high level during the first period t1 of the first frame period Frame1. The hold line HLD may supply the hold signal HD of a low level during the first and second periods t1 and t2 of the first frame period Frame1. The fourth transistor T4 may be turned on during the first period t1, and the hold line HLD may supply the hold signal HD of a low level to the third node N3. Accordingly, each of the fifth and sixth transistors T5 and T6 may be turned off based on the voltage of the third node N3 during the first and second periods t1 and t2 of the first frame period Frame1.

The second scan line SCL2 may supply the second scan signal SC2 of a high level during the first period t1 of the first frame period Frame1. The second scan line SCL2 may supply the second scan signal SC2 of a low level during the second period t2 of the first frame period Frame1.

The second transistor T2 may be turned on during the first period t1 of the first frame period Frame1 to supply the data voltage Vdata to the first node N1, which is the gate electrode of the first transistor T1. The third transistor T3 may be turned on during the first period t1 of the first frame period Frame1, and the second node N2, which is the source electrode of the first transistor T1, may be discharged to the initialization voltage Vint. Accordingly, the gate-source voltage (Vgs) of the first transistor T1 may be greater than the threshold voltage (Vth) of the first transistor T1.

Since the first transistor T1 may be turned on during the second period t2 of the first frame period Frame1, the drain-source current (Ids) may flow in the first transistor T1. As the drain-source current (Ids) flows during the second period t2, the voltage VN1 of the first node N1 and the voltage VN2 of the second node N2 may increase. The light-emitting element ED may receive the drain-source current (Ids) of the first transistor T1 and emit light.

The sub-pixel SP may be driven during a sensing section of a second frame period Frame2. The first scan line SCL1 may supply the first scan signal SC1 of a high level during the first period t1 of the second frame period Frame2. The hold line HLD may supply the hold signal HD of a high level during the first period t1 of the second frame period Frame2. The fourth transistor T4 may be turned on during the first period t1, and the hold line HLD may supply the hold signal HD of a high level to the third node N3. The hold signal HD of a high level may be charged to the third node N3, which is the first electrode of the second capacitor C2.

Each of the fifth and sixth transistors T5 and T6 may be turned on based on the voltage of the third node N3 during the first and second periods t1 and t2 of the second frame period Frame2. The fifth transistor T5 may be turned on during the first and second periods t1 and t2 of the second frame period Frame2 to supply the reference voltage Vref to the first node N1, which is the gate electrode of the first transistor T1. Accordingly, the voltage VN1 of the first node N1 may correspond to the reference voltage Vref during the first and second periods t1 and t2. The sixth transistor T6 may be turned on during the first and second periods t1 and t2 of the second frame period Frame2 to electrically connect the second node N2, which is the source electrode of the first transistor T1, to the sensing line SEN.

The second scan line SCL2 may supply the second scan signal SC2 of a high level during the first period t1 of the second frame period Frame2. The third transistor T3 may be turned on during the first period t1, and the second node N2, which is the source electrode of the first transistor T1, may be discharged to the initialization voltage Vint. Accordingly, the voltage VN2 of the second node N2 may correspond to the initialization voltage Vint during the first period t1.

During the first period t1 of the second frame period Frame2, the gate-source voltage (Vgs) of the first transistor T1 may be greater than the threshold voltage Vth of the first transistor T1, and the first transistor T1 may be turned on during the second period t2 so that the drain-source current (Ids) may flow in the first transistor T1. The voltage VN2 of the second node N2 may increase until the gate-source voltage (Vgs) of the first transistor T1 becomes equal to the threshold voltage (Vth). The drain-source current (Ids) flowing in the first transistor T1 may flow to the sensing line SEN when the sixth transistor T6 is turned on. The sixth transistor T6 may supply the voltage VN2 of the second node N2 to the sensing line SEN as a sensing signal, and the display driver 200 may recognize the change in the threshold voltage (Vth) of the first transistor T1 according to a magnitude of the sensing signal.

The sub-pixel SP may be driven during a driving section of a third frame period Frame3. The sub-pixel SP may be driven in a similar manner to the first frame period Frame1 in the third frame period Frame3, and the light-emitting element ED may receive the drain-source current (Ids) of the first transistor T1 and emit light.

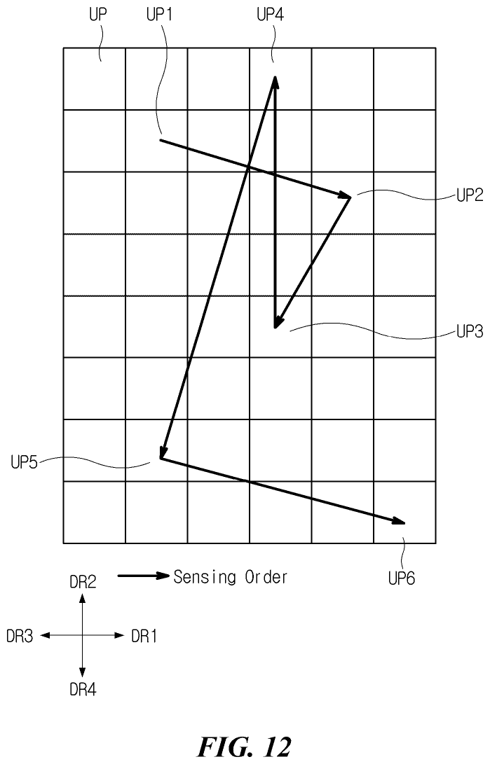

FIG. 12 is a view illustrating an example of a sensing method in the display apparatus according to one embodiment.

Referring to FIG. 12, some of the plurality of pixels UP may be driven during the driving section, and others may be driven during the sensing section. A pixel UP to be sensed among the plurality of pixels UP may be randomly determined.

For example, first to sixth pixels UP1, UP2, UP3, UP4, UP5, and UP6 may be sequentially sensed. The first pixel UP1 may be first sensed among the first to sixth pixels UP1, UP2, UP3, UP4, UP5, and UP6, and the other pixels UP may be driven during the driving section. A second pixel UP2 may be disposed in a diagonal direction between the first direction DR1 and a fourth direction DR4 of the first pixel UP1. A third pixel UP3 may be disposed in a diagonal direction between the third direction DR3 and the fourth direction DR4 of the second pixel UP2. A fourth pixel UP4 may be disposed in the second direction DR2 of the third pixel UP3. A fifth pixel UP5 may be disposed in a diagonal direction between the third direction DR3 and the fourth direction DR4 of the fourth pixel UP4. The sixth pixel UP6 may be disposed in a diagonal direction between the first direction DR1 and the fourth direction DR4 of the fifth pixel UP5. The sensing method of the pixels UP is not limited thereto.

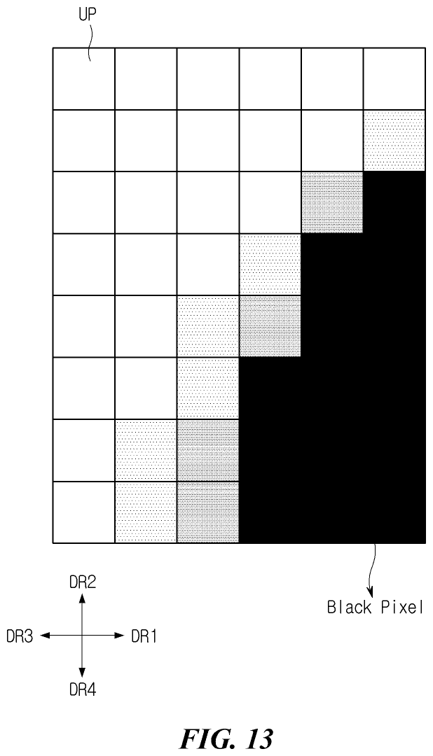

FIG. 13 is a view illustrating an example of the sensing method in the display apparatus according to one embodiment.

Referring to FIG. 13, black pixels Black Pixel among the plurality of pixels UP may be driven during the sensing section, and the other pixels UP may be driven during the driving section. Here, the black pixel Black Pixel may be determined according to the magnitude of the data voltage Vdata and changed for each frame.

The display apparatus 10 according to various embodiments of the present specification may be described as follows.

According to various embodiments of the present specification, there is provided a display apparatus including a light-emitting element that emits light, a first transistor that controls a driving current flowing in the light-emitting element, a second transistor that supplies a data voltage to a first node, which is a gate electrode of the first transistor, based on a first scan signal, a third transistor that supplies an initialization voltage to a second node, which is a source electrode of the first transistor, based on a second scan signal, a fourth transistor that supplies a hold signal to a third node, based on the first scan signal, a fifth transistor that electrically connects a reference voltage line to the first node based on a voltage of the third node, and a sixth transistor that electrically connects the second node to a sensing line based on a voltage of the third node.

The display apparatus according to various embodiments of the present specification may further include a first capacitor connected between the first node and the second node, and a second capacitor connected between the third node and the reference voltage line.

In the display apparatus according to various embodiments of the present specification, in a sensing section in which a threshold voltage of the first transistor is sensed, each of the first and second scan signals and the hold signal may have a high level during a first period of one frame period.

In the display apparatus according to various embodiments of the present specification, in the sensing section, each of the first and second scan signals and the hold signal may have a low level during a second period after the first period.

In the display apparatus according to various embodiments of the present specification, in the sensing section, each of the second to fourth transistors may be turned on during the first period, and each of the fifth and sixth transistors may be turned on during the second period.

In the display apparatus according to various embodiments of the present specification, in the sensing section, the first transistor may be turned on during the second period, and the sixth transistor may supply a voltage of the second node as a sensing signal to the sensing line.

In the display apparatus according to various embodiments of the present specification, in a driving section in which the light-emitting element emits light, each of the first and second scan signals may have a high level during a first period of one frame period, and the hold signal may have a low level during the first period.

In the display apparatus according to various embodiments of the present specification, in the driving section, each of the first and second scan signals and the hold signal may have a low level during a second period after the first period.

In the display apparatus according to various embodiments of the present specification, in the driving section, each of the second to fourth transistors may be turned on during the first period, and each of the fifth and sixth transistors may be turned off during the second period.

In the display apparatus according to various embodiments of the present specification, in the driving section, the first transistor may be turned on during the second period, and the light-emitting element may receive a driving current flowing in the first transistor and emit light.

The display apparatus according to various embodiments of the present specification may further include a 1-1 pixel disposed in a first row and a first column, a 1-2 pixel disposed in the first row and a second column following the first column, a 2-1 pixel disposed in a second row following the first row and the first column, and a 2-2 pixel disposed in the second row and the second column, in which each of the 1-1 pixel, the 1-2 pixel, the 2-1 pixel, and the 2-2 pixel includes first to third sub-pixels that emit light of different colors, and each of the first to third sub-pixels may include the first to sixth transistors.

The display apparatus according to various embodiments of the present specification may further include a data line that extends in a first direction and supplies the data voltage to the 1-1 pixel, the 1-2 pixel, the 2-1 pixel, and the 2-2 pixel, a first hold line that extends in the first direction and supplies the hold signal to the first to third sub-pixels of the 1-1 pixel, and the first to third sub-pixels of the 2-1 pixel, and a second hold line that extends in the first direction and supplies the hold signal to the first to third sub-pixels of the 1-2 pixel, and the first to third sub-pixels of the 2-2 pixel.

The display apparatus according to various embodiments of the present specification may further include a first sensing line that extends in the first direction and receives a sensing signal of the first sub-pixel of each of the 1-1 pixel, the 1-2 pixel, the 2-1 pixel, and the 2-2 pixel, a second sensing line that extends in the first direction and receives a sensing signal of the second sub-pixel of each of the 1-1 pixel, the 1-2 pixel, the 2-1 pixel, and the 2-2 pixel, and a third sensing line that extends in the first direction and receives a sensing signal of the third sub-pixel of each of the 1-1 pixel, the 1-2 pixel, the 2-1 pixel, and the 2-2 pixel.

According to various embodiments of the present specification, there is provided a display apparatus including a data line that supplies a data voltage, a display driver that supplies the data voltage to the data line, an initialization voltage line that supplies an initialization voltage, a reference voltage line that supplies a reference voltage, a light-emitting element that emits light during a driving section that is some of a plurality of frame periods, a sensing line that supplies a sensing signal to the display driver during a sensing section that is the other parts of the plurality of frame periods, a hold line that supplies a hold signal, a first transistor that controls a driving current flowing in the light-emitting element, a second transistor electrically connecting the data line to a first node that is a gate electrode of the first transistor based on a first scan signal, a third transistor electrically connecting the initialization voltage line to a second node that is a source electrode of the first transistor based on a second scan signal, a fourth transistor electrically connecting the hold line to a third node based on the first scan signal, a fifth transistor electrically connecting the reference voltage line to the first node based on a voltage of the third node, a sixth transistor electrically connecting the second node to the sensing line based on the voltage of the third node, a first capacitor connected between the first node and the second node, and a second capacitor connected between the third node and the reference voltage line.

In the display apparatus according to various embodiments of the present specification, in the sensing section, each of the first and second scan signals and the hold signal may have a high level during a first period of one frame period.

In the display apparatus according to various embodiments of the present specification, in the sensing section, each of the first and second scan signals and the hold signal may have a low level during a second period after the first period.

In the display apparatus according to various embodiments of the present specification, in the sensing section, each of the second to fourth transistors may be turned on during the first period, and each of the fifth and sixth transistors may be turned on during the second period.

In the display apparatus according to various embodiments of the present specification, in the sensing section, the first transistor may be turned on during the second period, and the sixth transistor may supply a voltage of the second node as a sensing signal to the sensing line.

In the display apparatus according to various embodiments of the present specification, in the driving section, each of the first and second scan signals may have a high level during a first period of one frame period, and the hold signal may have a low level during the first period.

In the display apparatus according to various embodiments of the present specification, in the driving section, each of the second to fourth transistors may be turned on during the first period, each of the fifth and sixth transistors may be turned off during the second period, and the first transistor may be turned on during the second period and the light-emitting element may receive a driving current flowing in the first transistor and emit light.

In the display apparatus according to the embodiments of the present specification, the threshold voltages of the driving transistors of some pixels can be sensed in real time during display driving by including the first to sixth transistors and the first and second capacitors.

In the display apparatus according to the embodiments of the present specification, it is possible to improve the reliability of the display apparatus and reducing power consumption by sensing some pixels during display driving in real time.

However, effects obtainable from the present specification are not limited to the above-described effects, and other effects that are not mentioned will be able to be clearly understood by those skilled in the art to which the present specification pertains based on the following description.

Although one embodiment has been described above with reference to the accompanying drawings, those skilled in the art to which the specification pertains will be able to understand that the above-described technical configuration of the present disclosure can be carried out in other specific forms without changing the technical spirit or essential features thereof. Accordingly, it should be understood that the above-described embodiments are illustrative and not restrictive in all respects. In addition, the scope of the specification includes those of the claims. In addition, the meaning and scope of the claims and all changed or modified forms derived from the equivalent concept should be construed as being included in the scope of the specification.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display apparatus comprising:
a data line configured to supply a data voltage;
an initialization voltage line configured to supply an initialization voltage;
a reference voltage line configured to supply a reference voltage;
a light emitting element configured to emit light during a driving section;
a sensing line configured to receive a sensing signal during a sensing section;
a hold line configured to supply a hold signal;
a first transistor configured to control a driving current flowing in the light-emitting element;
a second transistor connected between the data line and a first node, which is a gate electrode of the first transistor;
a third transistor connected between the initialization voltage line and a second node, which is a source electrode of the first transistor;
a fourth transistor connected between the hold line and a third node;
a fifth transistor connected between the reference voltage line and the first node; and
a sixth transistor connected between the second node and the sensing line,
wherein gate electrodes of the fifth and sixth transistors are connected to the third node.

2. The display apparatus of claim 1, further comprising;
a first capacitor connected between the first node and the second node; and
a second capacitor connected between the third node and the reference voltage line.

3. The display apparatus of claim 2, wherein, during a first period in the sensing section, the third transistor is configured to be turned on to supply the initialization voltage to the second node, and the fourth transistor is configured to be turned on to supply the hold voltage to the third node.

4. The display apparatus of claim 3, wherein, during a second period after the first period in the sensing section, the second to fourth transistors are configured to be turned off.

5. The display apparatus of claim 4, wherein, in the sensing section, the fifth transistor is configured to be turned on to supply the reference voltage to the first node.

6. The display apparatus of claim 5, wherein, during the second period in the sensing section, the first and sixth transistors are configured to be turned on to supply a voltage of the second node as the sensing signal to the sensing line.

7. The display apparatus of claim 4, wherein the hold signal is configured to have a high level during the first period in the sensing section.

8. The display apparatus of claim 2, wherein, during a first period in the driving section, the second transistor is configured to be turned on to supply the data voltage to the first node, and the third transistor is configured to be turned on to supply the initialization voltage to the second node.

9. The display apparatus of claim 8, wherein, during a second period after the first period in the driving section, the second to sixth transistors are configured to be turned off.

10. The display apparatus of claim 9, wherein, during the second period in the driving section, the first transistor is configured to be turned on, and the light-emitting element is configured to receive the driving current flowing in the first transistor and emits light.

11. The display apparatus of claim 9, wherein the hold signal is configured to have a low level during the first period in the driving section.

12. The display apparatus of claim 1, further comprising a plurality of pixels,
wherein the plurality of pixels include:
a 1-1 pixel disposed in a first row and a first column;
a 1-2 pixel disposed in the first row and a second column following the first column;
a 2-1 pixel disposed in a second row following the first row and the first column; and
a 2-2 pixel disposed in the second row and the second column, and
wherein each of the 1-1 pixel, the 1-2 pixel, the 2-1 pixel, and the 2-2 pixel includes first to third sub-pixels that are configured to emit light of different colors, and
each of the first to third sub-pixels includes the first to sixth transistors.

13. The display apparatus of claim 12, wherein the hold line comprises:
a first hold line configured to supply the hold signal to the first to third sub-pixels of the 1-1 pixel, and the first to third sub-pixels of the 2-1 pixel; and
a second hold line configured to supply the hold signal to the first to third sub-pixels of the 1-2 pixel, and the first to third sub-pixels of the 2-2 pixel.

14. The display apparatus of claim 13, wherein the sensing line comprises:
a first sensing line configured to receive a sensing signal of the first sub-pixel of each of the 1-1 pixel, the 1-2 pixel, the 2-1 pixel, and the 2-2 pixel;
a second sensing line configured to receive a sensing signal of the second sub-pixel of each of the 1-1 pixel, the 1-2 pixel, the 2-1 pixel, and the 2-2 pixel; and
a third sensing line configured to receive a sensing signal of the third sub-pixel of each of the 1-1 pixel, the 1-2 pixel, the 2-1 pixel, and the 2-2 pixel.

15. The display apparatus of claim 12, wherein, during one frame period, some of the plurality of pixels are configured to be driven in the sensing section, and others of the plurality of pixels are configured to be driven in the driving section.

16. The display apparatus of claim 15, wherein black pixels among the plurality of pixels are configured to be driven in the sensing section.

17. A display apparatus comprising:
a data line configured to supply a data voltage;
an initialization voltage line configured to supply an initialization voltage;
a reference voltage line configured to supply a reference voltage;
a sensing line configured to receive a sensing signal during a sensing section;
a hold line configured to supply a hold signal; and
a plurality of pixels, each including a plurality of sub-pixels that emit light of different colors,
wherein each of the plurality of sub-pixels comprises:
a light emitting element configured to emit light during a driving section;
a driving transistor configured to control a driving current flowing in the light-emitting element;
a first capacitor connected between a first node that is a gate electrode of the driving transistor and a second node that is a source electrode of the driving transistor; and
a second capacitor connected between a third node and the reference voltage line,
wherein, in the sensing section,
the hold line is configured to be connected to the third node during a first period, and is configured to be disconnected from the third node during a second period after the first period, and
the first node is configured to be connected to the reference voltage line and the second node is configured to be connected to the sensing line based on a voltage of the third node.

18. The display apparatus of claim 17, wherein, in the sensing section, the initialization voltage line is configured to be connected to the second node during the first period and is configured to be disconnected from the second node during the second period.

19. The display apparatus of claim 18, wherein, during the second period in the sensing section, the driving transistor is configured to be turned on, and a voltage of the second node is configured to be supplied as the sensing signal to the sensing line.

20. The display apparatus of claim 17, wherein, in the driving section,
the hold line is configured to be connected to the third node during a first period and is configured to be disconnected from the third node during a second period after the first period, and
the first node is configured to be disconnected from the reference voltage line and the second node is configured to be disconnected from the sensing line based on the voltage of the third node.

21. The display apparatus of claim 20, wherein, during the first period in the driving section, the initialization voltage line is configured to be connected to the second node, and the data line is configured to be connected to the first node, and
during the second period of the driving section, the initialization voltage line is configured to be disconnected from the second node, the data line is configured to be disconnected from the first node, and the driving transistor is configured to be turned on to supply the light-emitting element with the driving current.

22. The display apparatus of claim 20, wherein the hold signal is configured to have different levels during the first period in the sensing section and during the first period in the driving section.

23. The display apparatus of claim 17, wherein, during one frame period, some of the plurality of pixels are configured to be driven in the sensing section, and others of the plurality of pixels are configured to be driven in the driving section.

24. The display apparatus of claim 23, black pixels among the plurality of pixels are configured to be driven in the sensing section.

25. The display apparatus of claim 17, wherein the plurality of sub-pixels in each pixel are connected to a same hold line.

26. The display apparatus of claim 25, wherein sub-pixels that emit light of same color in at least two adjacent pixels are connected to a same sensing line.
